(19) United States
(12) Patent Application Publication
(10) Pub. No.: US 2004/0253997 A1
(43) Pub. Date: Dec. 16, 2004

(54) Wireless test data transmission apparatus and method

(75) Inventor: Robert Kochie, Mantorville, MN (US)

Correspondence Address: BAKER & HOSTETLER LLP, Washington Square, Suite 1100, 1050 Connecticut Avenue, N.W., Washington, DC, 20036, US

(73) Assignee: SPX Corporation

(21) Appl. No.: 10/461,372

(22) Filed: Jun. 16, 2003

(51) Int. Cl. H04M 1/00

(52) U.S. Cl. 455/575.1; 455/90.3

(57) ABSTRACT

A method and apparatus provides wireless transmission of test data from a testing device such as a test probe to diagnostic testing equipment.

### FIELD OF THE INVENTION

The present invention relates generally to transferring test data to diagnostic equipment. More particularly, the present invention relates to wireless transmission of test data to diagnostic equipment for monitoring and/or analyzing the test data by the diagnostic equipment.

### BACKGROUND OF THE INVENTION

A proliferation of testing products exist in the industrial market and within the general electronics market for making electrical measurements. Such measurements may include, for example, volts, ohms, and/or amps. Typically, some sort of probe is utilized to measure, for example, voltage in an electronics device. In most cases, the probe (which may consist of any number of available products, including, for example, a banana type input jack, a B&C connector, a standard test lead, or an alligator clip) is hard wired to a test instrument which is configured to receive diagnostic data collected by the probe. The diagnostic data may be monitored and/or analyzed by the test instrument for a variety of purposes. One of the many purposes may be to analyze vehicle test data in the auto-service industry.

The demands placed on an automobile service technician have increased with the increasing complexity of modern vehicles. The systems of vehicles have grown in complexity to reduce pollution and increase safety and comfort. Technicians are required to perform their diagnosis of a vehicle's system quickly and efficiently, to increase profits of the service station and minimize the amount of time that people's cars spend in the repair shop. Moreover, while performing these tasks technicians are often require to simultaneously attend to other matters. To meet the needs of the technician serving today's cars, an increasing array of test equipment has been made available for testing the various systems of cars. The following United States Patents relate to such test equipment.

U.S. Pat. No. 4,298,837 discloses a handheld testing device that functions as a multimeter and has a switch for independently selecting functions and ranges for measuring different electrical quantities.

U.S. Pat. No. 5,367,250 discloses a handheld instrument for performing voltage and continuity tests on electrical systems of vehicles. Red and green LEDs mounted in the housing are operatively interconnected with the probe and power cable through circuitry that causes the red LED to glow when the probe contacts a positive voltage and the green LED to glow when the LED contacts a negative voltage.

U.S. Pat. No. 5,541,840 discloses a system that includes a handheld scan tool that is adapted to interface to the automobile and communicate with various on-board controllers to monitor the operation of the vehicle in real time. While the handheld tool can function as a digital multimeter, it is required to receive information from an on-board controller having a communication bus for communicating with external devices.

U.S. Pat. No. 5,834,935 discloses a digital multimeter with a housing having a battery compartment. A removable battery cover encloses the battery compartment, and has a probe aperture registered with the probe connector, so that a probe may be connected when the battery cover is installed.

While the aforementioned patents provide useful diagnostic testing equipment in the auto-service and general electronics industry, they all desire a hardwired connection from their test probes to their respective diagnostic equipment to convey testing information for further processing. This kind of wired setup may prove undesirable or limiting in a variety of applications.

For example, it is sometimes necessary to perform diagnostic testing on a vehicle while it is moving in order to simulate conditions and/or receive accurate information for diagnosis. Using conventional testing equipment, an auto-service technician may typically connect a test probe wired to a testing device to an interface located on the vehicle to communicate with various on-board controllers in order to monitor and/or diagnose the operation of the vehicle. This may present a potentially inconvenient situation, because the wires connecting the probe and the testing device should remain clear of any spinning and/or moving components located within the vehicle. Additionally, if wires are strung outside of the vehicle, it is also desirable that they remain clear of foreign objects outside of the vehicle while it is moving during the test cycle.

There is thus a particular need for providing a convenient and easy to use manner in which test data can be delivered to diagnostic testing equipment in order to diagnose and/or monitor the performance of a vehicle.

### SUMMARY OF THE INVENTION

The foregoing needs are met, to a great extent, by the present invention, wherein in one aspect an apparatus is provided that in some embodiments provides a wireless transmission of test data from a vehicle to diagnostic testing equipment.

In accordance with one embodiment of the present invention, an apparatus is provided to include a wireless transmission. of data to a test instrument including a test probe having an input connector. A transmitter device transmits data collected by the test probe. The transmitter device has a first connector received by the input connector of the test probe. A test instrument is also provided having at least one input connector. A receiver device receives data transmitted by the transmitter device. The receiver device has at least one second connector to be received by the at least one input connector of the test instrument.

In accordance with another embodiment of the present invention, a method is provided for providing wireless transmission of data to a test instrument including providing a test probe and connecting a transmitter device to the test probe. A testing instrument is also provided and a receiver device is connected to the testing instrument. The probe is used to collect data and the data is transmitted from the transmitter device to the testing instrument via the receiver device.

In accordance with yet another embodiment of the present invention, a system is provided for wireless transmission of data to a test instrument including a means for gathering data and a means for connecting a means for transmitting data to the gathering data means. The system also provides a means for testing and a second means for connecting a means for receiving data to the testing means.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating an arrangement of a test instrument wirelessly communicating wtih a vehicle.

FIG. 2 is illustrates a wireless transmission connection between a test probe and a test instrument in accordance with an embodiment of the invention.

FIG. 3 is a perspective view of a test instrument which may be utilized in an embodiment of the invention.

### DETAILED DESCRIPTION

Embodiments of the invention provide a method and apparatus that provides wireless transmission of test data from a vehicle to diagnostic testing equipment. This is accomplished by, for example, collecting test data from a vehicle using standard test probes having standard input connectors in which a transmitter means may be inserted to transmit collected test data in accordance with the present invention, and receiving and delivering the transmitted test data to diagnostic testing equipment having input connectors to which a receiver may be attached.

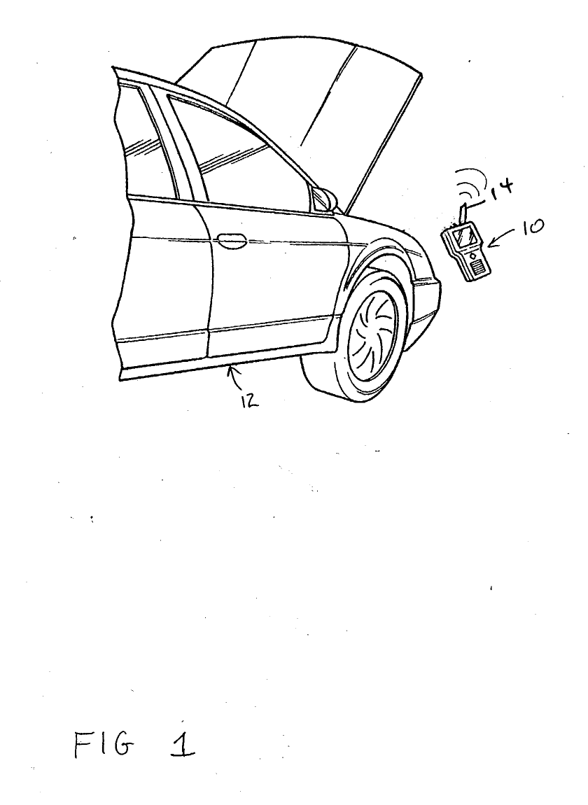

The invention will now be described with reference to the drawing figures, in which like reference numerals refer to like parts throughout. FIG. 1 shows a diagnostic testing equipment 10 communicating with to a vehicle 12 via an antenna 14 which is shown schematically and is preferably an internal antenna to the equipment 10 housing. The diagnostic testing equipment 10 may be a handheld scan tool adapted to interface to the automobile and communicate with various on-board controllers to monitor the operation of the vehicle in real time. The use of wireless communication can avoid, for example, clearance hazards by avoiding a need for proper clearance between the PRIOR ART wires and any objects with which the wires may interfere. This may include, for example, spinning or moving components of the engine. Another benefit of wireless communication is that the vehicle can be driven during testing, and clearance does not need to be maintained between the PRIOR ART wires and foreign objects, such as rocks, debris, or even the vehicles' tires.

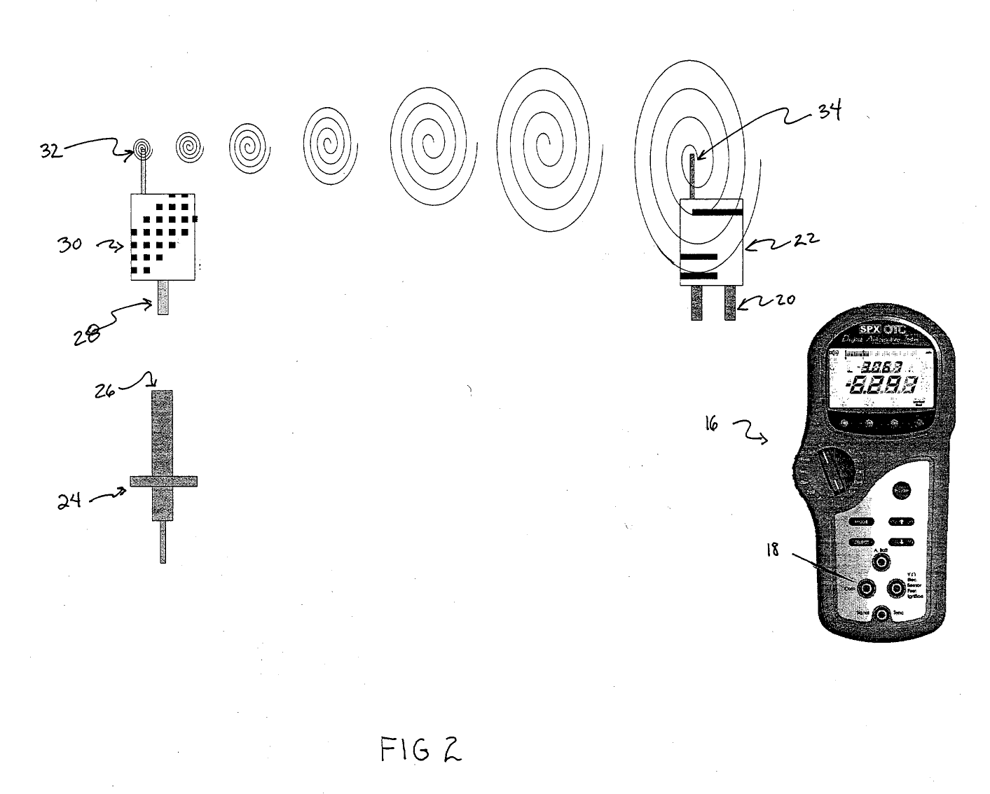

An embodiment of the present inventive apparatus and method is further illustrated in FIG. 2. A diagnostic test instrument 16 is shown having at least one input connector 18 to accommodate a connector(s) 20 of a receiver device 22. In both the diagnostic test instrument 16 and the receiver device 22, a standard input and connector type, respectively, are preferred. The diagnostic test instrument 16 shown in FIG. 2 is for illustrative purposes only. Other diagnostic equipment may be utilized to connect with a wireless receiver means.

A test probe 24 is provided having an input connector 26. The test probe 24 may be any of a wide variety of probe adapters suitable for interfacing with various on-board controllers to gather information from various vehicle system components. The input connector 26 of the test probe is 24 receives a connector(s) 28 of a transmitter device 30. In both the test probe 24 and the transmitter device 30, a standard input and connector type, respectively, may be used in a preferred embodiment of the invention.

The transmitter device 30 receives the information collected by the test probe 24. The information received by the transmitter device 30 is transmitted through wireless signals to the receiver device 22. An antennae 32 is schematically illustrated connected to the transmitter device 30 and is used to communicate with a schematically illustrated antennae 34 of the receiver device 22. Other wireless means may be utilized to allow the transmitter device 30 to communicate with the receiver device 22. In a preferred embodiment of the invention, the information is sent through short range RF transmission. However, other alternatives of wireless communication may be utilized to transmit and receive the information such as, for example, infrared transmission.

In operation, the connector(s) 20 of the receiver device 22 is connected to the input connector 18 of the diagnostic test instrument 16. Likewise, the connector(s) 28 of the transmitter device 30 is connected with the input connector 26 of the test probe 24. The test probe 24 registers data from a vehicle and communicates the information to the transmitter device 30 via connectors 26, 28. The transmitter device 30 sends the information to the receiver device 22.

One example of transmitting the information from the transmitter device 30 to the receiver device 22 may be through short range RF transmission. Other alternatives of wireless communication may be utilized to transmit and receive the data such as, for example, infrared transmission. Once the data is received by the receiver device 22, the data is sent to the diagnostic test instrument 16 via the connectors 18, 20. Once the data is sent to the diagnostic test instrument 16, the information may be analyzed or monitored by a technician using the diagnostic test instrument.

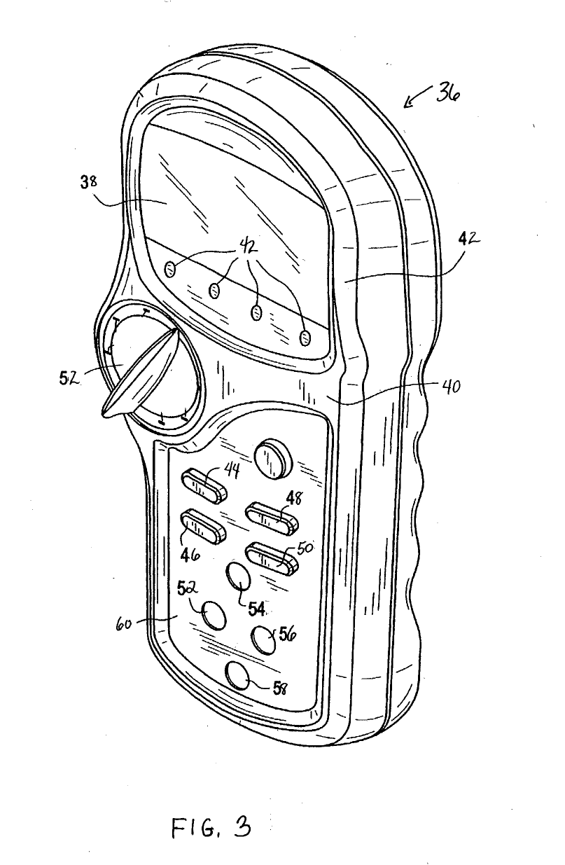

FIG. 3 shows an example of a kind of diagnostic test instrument 16 known as a handheld digital automobile tester (DAT) 36. The DAT has a housing 32 with a display screen 38 on the front surface 40 of the housing near the upper end 42. Below the display screen 38 are four LEDs 42. On the front surface 40, below the LEDs 42 are four buttons: mode 44, select 46, toggle up 48, and toggle down 50. A dial 52 is mounted between the four buttons and the LEDs 42.

Four input connectors 52, 54, 56 and 58 are mounted on the front surface 40 near the lower end of the housing 60. The four input/out jacks are a common jack 52, an amps/battery jack 54, voltage, ohm, electric sensor, fuel ignition jack 56 and a signal/sync jack 58 all of which are adapted to receive input from other electrical equipment.

This particular diagnostic test instrument 16 has the ability to diagnose and monitor the performance of vehicles and can also function as a multimeter. For instance, the DAT 36, depending on how the device is set, can measure at least volts, ohms, and amps. In the voltage setting, the units will default to auto-ranging D/C Volts. An icon “Auto” will be illuminated as will the units “V” in the display screen 38. The A/C readings under this selection will be True RMS.

The common jack 52 and volt input jack 56 will be utilized in combination with the connectors of the receiver 20 for measuring data for this test. When measuring ohms, the common jack 52 and volts input jack 56 are utilized in combination with the connectors of the receiver 20 for this test. In order to measure amps, the common jack 52 and the amp input jacks 54 are utilized in combination with the connectors of the receiver 20 for this test.

Although an example of the diagnostic test instrument 16 is shown, it will be appreciated that other diagnostic equipment including, for instance, standard test instruments such as lab scopes or oscilloscopes and multimeters can be used.

Also, although the method and apparatus described herein is useful to transfer test data via wireless transmission equipment in order to diagnose and/or monitor the performance of vehicles, it can also be used in other applications including, for example, measuring voltages in power lines from safe distances via wireless transmission.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus for providing wireless transmission of data to a test instrument, comprising:
a test probe having an input connector;
a transmitter device having a first connector to be received by said input connector, said transmitter device transmits data collected by said test probe;
a test instrument having at least one input connector; and
a receiver device having at least one second connector to be received by said at least one input connector of said test instrument, said receiver device receives data transmitted by said transmitter device.

2. The apparatus of claim 1, wherein said test instrument further comprises:
a plurality of input connectors.

3. The apparatus of claim 2, wherein said receiver device further comprises:
a plurality of second connectors.

4. The apparatus of claim 1, wherein said transmitter device transmits data wirelessly to said receiver device.

5. The apparatus of claim 4, wherein said data is transmitted via RF transmission.

6. The apparatus of claim 4, wherein said data comprises:
vehicle test data.

7. The apparatus of claim 1, wherein said test instrument is one of an oscilloscope, a multimeter, and an engine analyzer.

8. The apparatus of claim 7, wherein said test instrument measures one of volts, ohms, and amps.

9. A method of providing wireless transmission of data to a test instrument comprising:
providing a test probe;
connecting a transmitter device to the test probe;
providing a testing instrument;
connecting a receiver device to the testing instrument;
using said probe to collect data; and
transmitting the data from the transmitter device to the testing instrument via said receiver device.

10. The method of claim 9, further comprising:
transmitting the data via RF transmission.

11. The method of claim 9, wherein the transmitted data comprises:
vehicle test data.

12. The method of claim 9, further comprising:
analyzing said transmitted data with the testing instrument.

13. The method of claim 9, further comprising:
monitoring said transmitted data with the testing instrument.

14. A system of providing wireless transmission of data to a test instrument comprising:
means for gathering data;
first means for connecting a means for transmitting data to said gathering data means;
means for testing; and
second means for connecting a means for receiving data to said testing means.

15. The system of claim 14, wherein said testing means further comprises a plurality of input connectors.

16. The system of claim 14, wherein said testing means further comprises: a testing instrument.

17. The system of claim 16, wherein said testing instrument monitors transmitted data.

18. The system of claim 16, wherein said testing instrument analyzes transmitted data.

19. The system of claim 14, wherein said transmitting means transmits said data wirelessly to said receiver device.

20. The system of claim 16, wherein said testing instrument is one of an oscilloscope, a multimeter, and an engine analyzer.

21. The system of claim 20, wherein said test instrument measures one of volts, ohms, and amps.
